(19) United States
(12) Patent Application Publication
(10) Pub. No.: US 2004/0215970 A1
(43) Pub. Date: Oct. 28, 2004

(54) Data recording apparatus and method of identifying data

(76) Inventors: Yuji Handa, Ueda-shi (JP); Kazuki Takahashi, Ueda-shi (JP)

Correspondence Address: BIRCH STEWART KOLASCH & BIRCH, PO BOX 747, FALLS CHURCH, VA, 22040-0747, US

(21) Appl. No.: 10/828,289

(22) Filed: Apr. 21, 2004

(30) Foreign Application Priority Data
Apr. 22, 2003 (JP) 2003-116601

(51) Int. Cl. H04K 1/00

(52) U.S. Cl. 713/193

(57) ABSTRACT

The data recording apparatus is capable of writing an identification datum, which identifies that data written in a recording medium are encrypted, in the recording medium so as to know if the recorded data are encrypted or not when they are read. In the apparatus, a control unit stores data sent from outside in a storing unit, encrypts the data stored in the storing unit and/or data of a system area of the recording medium by a encrypting unit, on the basis of a password, so as to make the encrypted data and/or the encrypted system area data, writes the encrypted data and/or the encrypted system area data in the recording medium by a writing unit, and writes the identification datum in the recording medium by the writing unit.

### BACKGROUND OF THE INVENTION

The present invention relates to a data recording apparatus and a method of identifying data recorded in a recording medium.

Conventionally, data are encrypted, by encrypting programs, so as to keep secrecy of the data. Encrypting programs encrypt data on the basis of algorithms defined therein. To access to the encrypted data, a user inputs a password, which has been assigned, then the encrypted data are decrypted on the basis of a decrypting algorithm, which corresponds to an encrypting algorithm. The user can actually use the data after the data are decrypted.

Namely, data are encrypted and decrypted by application programs, but a data recording and reading apparatus, which is capable of encrypting and decrypting data, is disclosed in Japanese Patent Gazette No. 01-227272.

However, the Japanese Patent Gazette does not describe about a password, which is an important factor of data encryption. Determining a password by user and an encrypting process based on the password are not described. In the apparatus, ordinary data (data not encrypted) are merely encrypted on the basis of an algorithm stored in a data encrypting unit.

Anybody can easily decrypt the data, which are encrypted by the apparatus disclosed in the Japanese Patent Gazette, by the same apparatus, so that the secrecy of the data cannot be kept.

Further, encrypting ordinary data by encrypting programs and decrypting encrypted data by decrypting programs apply great loads to a CPU of a computer. Therefore, the computer cannot work smoothly while encrypting and decrypting data.

To solve the problems, the inventors of the present invention invented a data processing apparatus, which was filed as Japanese Patent Application No. 2003-014219. In the apparatus, a password for decrypting encrypted data is optionally determined by a user.

However, the user musk know if the data recorded in the recording medium are encrypted or not when he uses the data. In the data processing apparatus of Japanese Patent Application No. 2003-014219, the user cannot know if the data are encrypted or not.

If data of a system area of the recording medium are encrypted, the data written in the recording medium cannot be recognized.

### SUMMARY OF THE INVENTION

An object of the present invention is to provide a data recording apparatus capable of writing an identification datum, which identifies that data written in the recording medium are encrypted, in the recording medium so as to know if the recorded data are encrypted or not when the recorded data are read.

Another object of the present invention is to provide a method of identifying data recorded in a recording medium, which is capable of knowing if the recorded data are encrypted or not.

To achieve the objects, the present invention has following structures.

The data recording apparatus comprises:

means for storing data;

means for encrypting data on the basis of a password determined by a user;

means for writing data in a recording medium;

means for controlling the storing means, the encrypting means and the writing means;

wherein the control means stores data, which are sent from outside of the apparatus, in the storing means,

encrypts the data stored in the storing means and/or data of a system area of the recording medium, which are used for recognizing the recording medium, by the encrypting means, on the basis of the password so as to make the encrypted data and/or the encrypted system area data,

writes the encrypted data and/or the encrypted system area data in the recording medium by the writing means, and

writes an identification datum, which identifies that the data written in the recording medium are encrypted, in the recording medium by the writing means.

With this structure, the identification datum is written when the data are written in the recording medium. Therefore, the use can know if the written data are encrypted or not by checking the identification datum. Further, in the case of reading the recording medium in which the system area data, e.g., a data format, directories, have been encrypted, the user can know if the recording medium is protected by encrypting data or not by checking the identification datum. The user can easily use the encrypted data recorded in the recording medium.

In the data recording apparatus, an ancillary password to be added to the password may be previously stored in the storing means, and

the control means may write a datum related to the ancillary password in the recording medium as the identification datum.

By adding the ancillary password, secrecy of the data can be further improved. Further, the datum related to the ancillary password, e.g., an attribute of the data, is written in the recording medium as the identification datum, the data can be securely decrypted.

In the data recording apparatus, the recording medium may be an optical disk, e.g., CD-R, CD-RW. In that case, the identification datum may be written in an RID area.

If the identification datum is written in the RID area of a CD-R or CD-RW, which is usually an unused area for reading data, the existence of the datum can be securely checked.

The method of the present invention comprises the steps of:

reading data, which are written in a recording medium by a data recording apparatus, in which the data are stored in storing means, the data stored in the storing means and/or data of a system area of the recording medium, which are used for recognizing the recording medium, are encrypted on the basis of a password so as to generate the encrypted data and/or the encrypted system area data, the encrypted data and/or the encrypted system area data are written in the recording medium, and an identification datum, which identifies that the data written in the recording medium are encrypted, are written in the recording medium; and

checking existence of the identification datum in the recording medium so as to identify if the data written in the recording medium are encrypted or not.

With this method, the use can know if the written data are encrypted or not by checking the existence of the identification datum. Therefore, The user can easily use the encrypted data recorded in the recording medium.

In the method, the optical disk may be a CD-R or a CD-RW, and the identification datum may be written in an RID area thereof. In this case, the RID area is usually an unused area for reading data, the existence of the identification datum can be securely checked.

### BRIEF DESCRIPTION OF THE DRAWINGS

Embodiments of the present invention will now be described by way of examples and with reference to the accompanying drawings, in which:

FIG. 1 is a block diagram of a first embodiment of the data recording apparatus;

FIG. 2 is an explanation view showing a structure of file system data;

FIG. 3 is a plan view of an optical disk including an area for writing an identification datum;

FIG. 4 is a block diagram of a second embodiment of the data recording apparatus; and

FIG. 5 is a flowchart of the action of the data recording apparatus of the second embodiment.

### DETAILED DESCRIPTION OF THE EMBODIMENTS

Preferred embodiments of the present invention will now be described in detail with reference to the accompanying drawings.

### First Embodiment

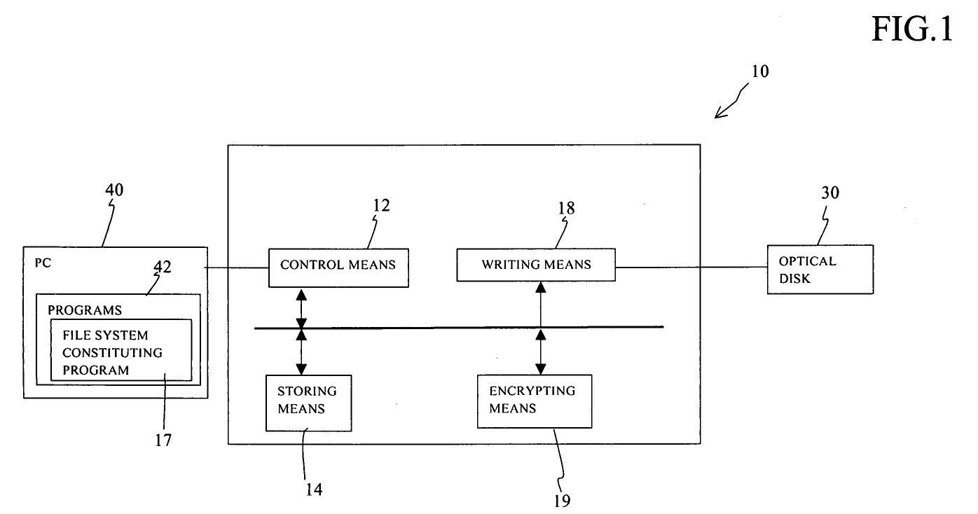

Firstly, an outline of a data processing apparatus of a first embodiment will be explained with reference to FIG. 1. The data recording apparatus of the first embodiment is an optical disk player having an encrypting function.

The optical disk player 10 is connected to an external apparatus 40, e.g., a personal computer (PC). The personal computer 41 has application programs 42, which include a file system constituting program 17. The file system constituting program 17 constitutes file system data of a recording medium 30, e.g., a removal optical disk. The file system data are data of a system area of the optical disk 30 and used for recognizing the optical disk 30.

The optical disk player 10 includes: means 14 for temporally storing ordinary data sent from the PC 40, e.g., RAM; means 19 for encrypting the stored ordinary data and/or the file system data on the basis of a password inputted by the program 42; means 18 for writing the encrypted data in the recording medium 30; and means 12 for controlling the storing means 14, the writing means 18 and the encrypting means 19.

Note that, the optical disk player 10 may have means for decrypting encrypted data.

The application programs 42 are installed in memories (not shown) of the PC 40. A user starts the application programs 42 of the PC 40 and inputs commands to the control means 12 so as to control the optical disk player 10.

When the user sends a start command, via the application program 42, to the optical disk player 10 so as to write data in the optical disk 30, the control means 12 temporarily stores the data in the storing means 14 of the optical disk player 10, then the writing means 18 writes the data, which have been stored in the storing means 14, in the optical disk 30.

As described above, the application programs 42 include the file system constituting program 17, which constitutes the data of the system area of the optical disk 30.

The file system data are control data for managing data files to be written in the optical disk 30.

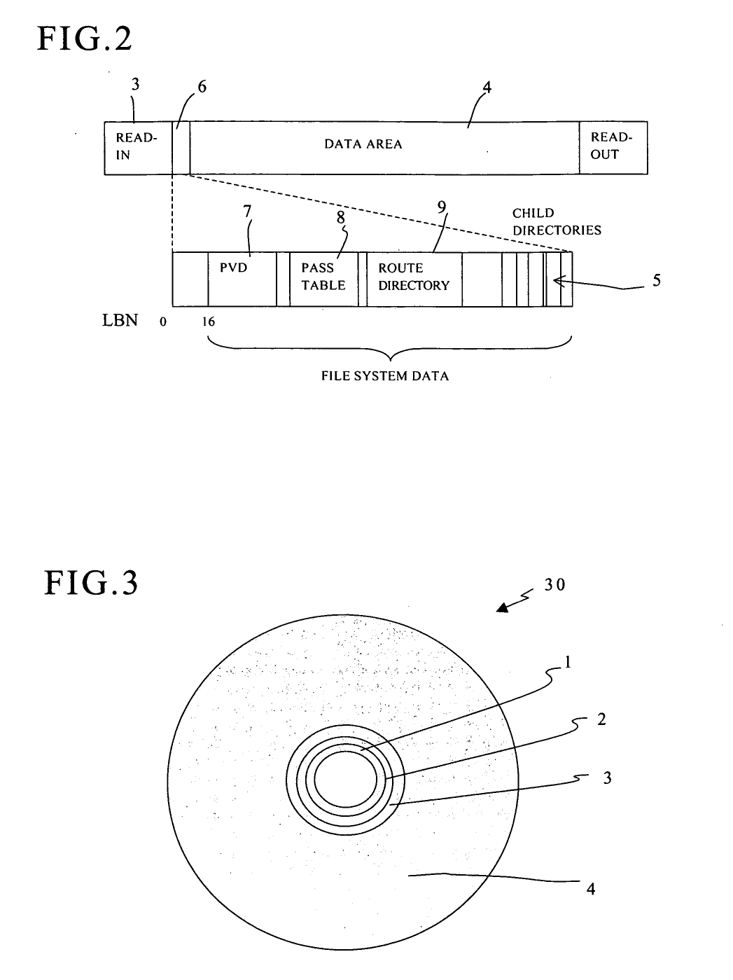

The file system data will be explained with reference to FIG. 2. FIG. 2 is an explanation view of a structure of the file system data in a system area 6.

According to ISO 9660, the system area 3 is located ahead of a data area 4. Logical blocks, each of which has a size of 2 kB, are serially arranged from a head of the system area 3. Logical block numbers (LBN) are assigned to the logical blocks. The file system data are written from the logical block LBN 16.

The file system data includes a primary volume descriptor (PVD) 7, a pass table 8 and a route directory 9, which includes child directories 5.

Identification of file format, sizes of volumes, a size of the pass table 8, addresses, etc. are written in the PVD 7.

Addresses of the child directories 5, which have layered structures, are written in the pass table 8. By reading the pass table 8, the addresses of the child directories 5, etc. can be known.

Note that, the structure of the file system data 6 is not limited to the structure based on ISO 9660. File system data based on other standards are located in other places.

In the present embodiment, the file system constituting program 17 forms data to be written into the layered structure before the writing means 18 writes the data in the optical disk 30, makes the file system data on the basis of a starting address and length of each file and writes them in the data area 4.

Note that, the file system data of the system area 6 can be encrypted on a password, which has been determined by a user and inputted via the application program 42, and written in the optical disk 30. Details will be described later.

By encrypting the file system data and writing them in the optical disk 30, the format and the starting address of each file, etc. of the data written in the optical disk 30 cannot be read by another optical disk player.

The encrypting means 19 encrypts the ordinary data and/or the file system data on the basis of the password, which have been determined by user and inputted via the application program 42.

Further, an ancillary password or passwords may be further used. By using the ancillary password or passwords, the secrecy of the encryption can be improved.

The ancillary passwords are, for example, data of the optical disk player 10, e.g., a serial number of the optical disk player 10, a type of the optical disk player 10, a name of a group whose members are permitted to access to the data. The ancillary passwords have been previously stored in the storing means 14. Further, some ancillary passwords may be determined before shipment; some ancillary passwords may be determined by users.

The password, which has been determined by the user, and the ancillary password are combined, and the combined password acts as an encryption key. Therefore, even if a third person gets the password, he or she cannot decrypt the encrypted data without the ancillary password. Note that, the encryption key may be constituted by the password only.

Further, the encryption key may be substantially constituted by the ancillary password. In this case, the combined password may be constituted by the password including no characters (blanks or spaces only) and the ancillary password.

The encrypting means 19 encrypts the file system data on the basis of a prescribed encrypting algorithm, which is selected form many known cryptosystems. In the present embodiment, the password determined by the user or the combined password, which includes the password determined by the user and the ancillary password, is used as the encryption key. For example, the key encryption may be used as a key of a private key cryptosystem, e.g., DES. The cryptosystem is not limited.

When the file system data are encrypted, at least a part of the data should be encrypted. For example, if the PVD 7 are encrypted, the file format of the optical disk 30 cannot be known, so that the secrecy of the main data can be kept.

The writing means 18 writes the encrypted data and/or the encrypted file system data in the data area 4 of the optical disk 30 and writes an identification datum or data, which identify that the data written in the recording medium 30 are encrypted, in an area the recording medium 30 other than the data area 4.

In the case of employing a CD-R or a CD-RW as the optical disk 30, the identification datum or data are written in, for example, an RID area 2 (see FIG. 3). As shown in FIG. 3, the RID area 4 is located between a PCA area 1, which is the innermost area of the optical disk 30 and in which power calibration test will be executed, and a read-in area 3, in which reference data related to the data written in the data area 4 will be written. In some cases, data of a data recording apparatus, which wrote data in the optical disk 30, are written in the RID area 2, but no data are usually written therein.

Note that, an area for writing the identification datum or data is not limited to the RID area 2.

Next, the identification datum or data will be explained.

In the present embodiment, the identification datum is a mere flag “0” or “1”.

When the ordinary data and/or the file system data are encrypted and written in the optical disk 30, the writing means 18 writes “1” in the RID area 2 as the identification datum. On the other hand, the ordinary data and/or the file system data are written in the optical disk 30 without encrypting them, the writing means 18 writes “0” in the RID area 2 as the identification datum.

Further, in the case of adding the ancillary password to the password, the writing means 18 writes a datum or data related to the ancillary password in the RID area 2 of the recording medium 30 as the identification datum or data. The datum or data are added to the identification datum “1”, which have been already written in the RID area 2.

For example, if the ancillary password is a serial number of the optical disk player 10, the writing means 18 further writes “2” in the RID area 2; if the ancillary password is a type of the optical disk player 10, the writing means 18 further writes “3” in the RID area 2.

There are three ways of encryption: encrypting the ordinary data only; encrypting the file system data only; and encrypting the ordinary data and the file system data. In any ways, the identification datum or data should be written in a prescribed area, e.g., the RID area 2, of the recording medium 30.

The means for inputting the password, etc. may be provided to a body proper of the optical disk player 10 instead of the PC 40.

Note that, the data of the system area 6 may be a table of contents (TOC), data in a program memory area (PMA), etc. instead of the file system data.

### Second Embodiment

Next, the method of identifying data recorded in a recording medium will be explained. In the present embodiment, the method is performed in an optical disk player.

The optical disk player is capable of reading and playing back data recorded in a recording medium, e.g., CD-R, CD-RW. Note that, the optical disk player may have means for decrypting encrypted data.

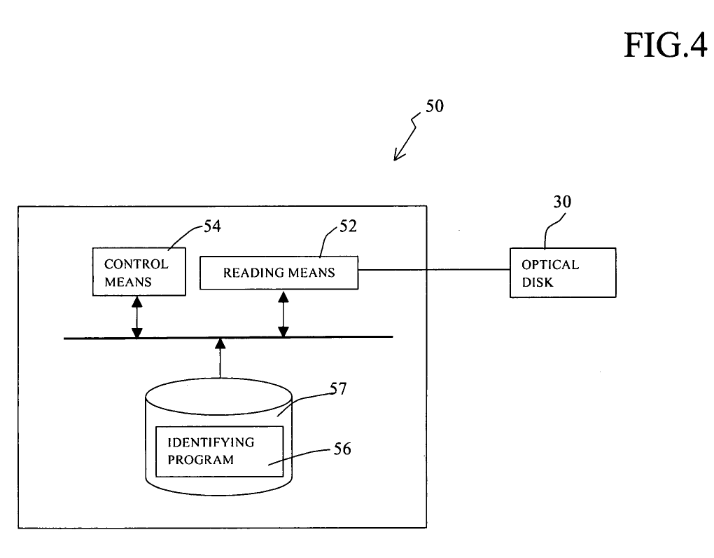

Firstly, a structure of the optical disk player will be explained with reference to FIG. 4.

The optical disk player 50 includes: means 52 for reading data from the recording medium 30, e.g., an optical disk; and means 54 for controlling the reading means 52, etc. so as to analyze the data read from the optical disk 30.

The control means 54 includes a CPU, memories, etc. and controls the whole system of the optical disk player 50 on the basis of control programs.

The control means 54 reads and executes an identifying program 56, which identifies if the data written in the recording medium (30) are encrypted or not by checking existence of an identification datum or data in the optical disk 30. The identifying program 56 has been previously stored in storing means 57.

Note that, the optical disk player 50 may have means for writing data in the optical disk 30. In this case, for example, an external apparatus, e.g., a personal computer, is connected to the optical disk player 50, and data are written by an application program of the external apparatus.

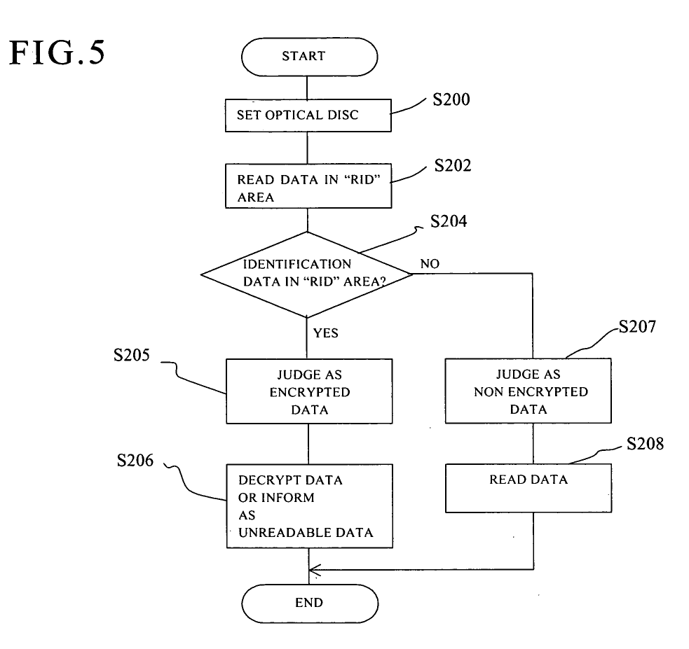

Next, the method of identifying data recorded in the optical disk 30, which is executed by the optical disk player 50, will be explained with reference to a flowchart of FIG. 5.

When the optical disk 30 is set in the optical disk player 50 (step S200), the reading means 52 reads data in a prescribed area of the optical disk 30, e.g., an RID area 2 of a CD-R or CD-RW (step S202).

The control means 54 checks if the identification datum or data exist in the RID area 2 or not (step S204). If the identification data exist in the RID area 2, the control means 54 judges that the recorded data and/or the recorded file system data are encrypted.

If the control mans 54 judges that the data recorded in the data area 4 and/or the file system data recorded in the system area 6 are encrypted (step S205), the control means 54 decrypts the encrypted data and/or the encrypted file system data. If the optical disk player 50 has no decrypting means, the control means 54 informs the user as unreadable data (step S206).

On the other hand, if the control mans 54 judges that the data and/or the file system data recorded in the optical disk 30 are not encrypted (step S207), the control means 54 reads the data recorded in the data area 4 as usual (step S208).

Note that, the recording medium is not limited to the above described optical disk. For example, a CD-R/RW, a DVD+R/RW, a DVD-RAM, a magnetic disk, an MO disk may be used. Further, the recording medium may be a removal medium or a fixed medium, and various types of media, e.g., optical disks, magnetic disks, optical-magnetic disks, can be used as the recording medium.

The invention may be embodied in other specific forms without departing from the spirit or essential characteristics thereof. The present embodiments are therefore to be considered in all respects as illustrative and not restrictive, the scope of the invention being indicated by the appended claims rather than by he foregoing description and all changes which come within the meaning and range of equivalency of the claims are therefore intended to be embraced therein.

What is claimed is:

1. A data recording apparatus,
comprising:
means for storing data;
means for encrypting data on the basis of a password determined by a user;
means for writing data in a recording medium;
means for controlling said storing means, said encrypting means and said writing means;
wherein said control means stores data, which are sent from outside of said apparatus, in said storing means,
encrypts the data stored in said storing means and/or data of a system area of the recording medium, which are used for recognizing the recording medium, by said encrypting means, on the basis of the password so as to make the encrypted data and/or the encrypted system area data,
writes the encrypted data and/or the encrypted system area data in the recording medium by said writing means, and
writes an identification datum, which identifies that the data written in the recording medium are encrypted, in the recording medium by said writing means.

2. The data recording apparatus according to claim 1,
wherein an ancillary password to be added to the password is previously stored in said storing means, and
said control means writes a datum related to the ancillary password in the recording medium as the identification datum.

3. The data recording apparatus according to claim 1,
wherein said recording medium is an optical disk.

4. The data recording apparatus according to claim 3,
wherein said optical disk is a CD-R or a CD-RW, and
the identification datum is written in an RID area.

5. A method of identifying data written in a recording medium,
comprising the steps of:
reading data, which are written in a recording medium by a data recording apparatus, in which the data are stored in storing means, the data stored in the storing means and/or data of a system area of the recording medium, which are used for recognizing the recording medium, are encrypted on the basis of a password so as to generate the encrypted data and/or the encrypted system area data, the encrypted data and/or the encrypted system area data are written in the recording medium, and an identification datum, which identifies that the data written in the recording medium are encrypted, are written in the recording medium; and
checking existence of the identification datum in the recording medium so as to identify if the data written in the recording medium are encrypted or not.

6. The method according to claim 5,
wherein the optical disk is a CD-R or a CD-RW, and
the identification datum is written in an RID area.
